(19) United States
(12) Patent Application Publication
(10) Pub. No.: US 2024/0382378 A1
(43) Pub. Date: Nov. 21, 2024

(54) CAP SUPPORTED INDICATOR FOR IDENTIFYING CONDITION TREATED BY MEDICATION

(71) Applicants: Jaafar M. Chehab, Sterling Heights, MI (US); Ahmad J. Chehab, Sterling Heights, MI (US); Moussa J. Chehab, Sterling Heights, MI (US); Ali J. Chehab, Sterling Heights, MI (US); Mohamed J. Chehab, Sterling Heights, MI (US)

(72) Inventors: Jaafar M. Chehab, Sterling Heights, MI (US); Ahmad J. Chehab, Sterling Heights, MI (US); Moussa J. Chehab, Sterling Heights, MI (US); Ali J. Chehab, Sterling Heights, MI (US); Mohamed J. Chehab, Sterling Heights, MI (US)

(21) Appl. No.: 18/318,028

(22) Filed: May 16, 2023

(51) Int. Cl. A61J 1/18; A61J 1/03; A61J 1/14

(52) U.S. Cl. CPC A61J 1/18; A61J 1/03; A61J 1/1425; A61J 2205/50

(57) ABSTRACT

An indicator for identifying a condition to be treated by a medication is disclosed. The indicator is supported on a cap that closes a medicine container. The indicator includes a base coupled to the cap and an upper component that extends upwardly away from the base and includes a first side and a second side. The first side and second side of the upper component includes a usage indicia, which includes a visual representation of a condition to be treated by the medication. The usage indicia is supported by the upper component such that the usage indicia is visible to the user. The upper component presents a surface area larger than the cap to display the visual representation. The first and second sides are planar for easier viewing of the visual representation while the container is stored.

### FIELD OF THE INVENTION

The present disclosure relates generally to an indicator for identifying a condition to be treated by a medication stored within a medicine container.

### BACKGROUND

Labels on medication containers can be very confusing. The FDA heavily regulates the information that must be included on prescription labels. For example, information on medication labels may include: pharmacy name and address, patient name and address, name and strength of drug, drug instructions, physical description of the drug, pharmaceutical manufacturer, discard date, federal caution statement, date prescription was written, pharmacist in charge, date drug was filled by pharmacy, number of pills in the bottle, date to place your refill order, pharmacy phone number, doctor's name, number used by pharmacy to identify your prescription, and number of times the patient can reorder the medication. Required information can be cumbersome to read and can cause users to confuse the required dosage, time of when they are supposed to take the medication, and the condition that is being treated by the medication. There are also restrictions on placing additional information on the prescription labels.

The amount of information can be an overwhelming for a user who may not know which information is important specifically for them. It is not uncommon for the font to be rather small to fit all this information onto the label. An elderly patient or a non-English speaking patient may have a hard time understanding what is written on the label. For patients who are prescribed many medications, it can be confusing having to view each medicine container label to figure out when that medication should be ingested. This can cause medications being taken at incorrect times or with incorrect dosages, which can be life-threatening to the patient.

Numerous visual indicators have been developed to aid patients in recognizing the medication contained within a medicine container. For example, U.S. Pat. No. 9,775,779 discloses a prescription bottle cap assembly and medication management system. This reference uses a visual reminder placed on top of the cap of the prescription bottle to help identify or correlate medication with a particular condition. The visual reminder can include dosage, dosage amount, and type of medication. The visual reminder can also be tactile by having a raised or textured image to help an elderly person, a person who is visually impaired, or otherwise disabled, to identify which medication is contained within the prescription pill bottle. However, the visual representation is limited in size due to being constrained by the surface area of the cap of the prescription bottle.

Another example is U.S. Patent Application Publication No. 2017/0333285, which discloses medication vial covers. This reference is directed at a cover for a medication vial, which is placed on top of the vial and has an identifier on top of the cover. Essentially, the vial cover acts as a replacement for the cap of the medicine vial. The identifier can include shapes and/or colors, which helps convey the type of medication contained within the vial. However, the identifier is limited in size because it is constrained by the surface area of the vial cover, which generally is the same size as the cap of the medicine vial.

Another example, U.S. Pat. No. 10,159,627 discloses a humidity-proof and child-resistant vial with improved identification means. This reference discloses a container, cap, and a hinge. The cap is constructed to include a child-safety lock and a scaling member, which prevents humidity buildup within the container. The cap has a recessed portion on top, which allows for a token to be received. The token may be used to add information such as identity of the patient, contents, and/or the time of day to take the medication. This information can be characterized by color, shapes, inscriptions, engraving or printing. The recessed portion of the cap is smaller in diameter than the cap itself, which limits the size of the token. The token's surface area is therefore smaller than the cap of the medicine container.

Although there have been attempts to help a patient identify important information regarding medication within a medication container, the existing solutions are constrained by the surface area of the medicine container and the surface area of the cap or lid of the medicine container. This is problematic as the font used can be very small, which would be difficult to read for elderly patients or for patients who have poor eyesight. Placing information regarding the medication on the body of the medicine container is cumbersome because containers are typically curved making it difficult to read. Also, traditional labels, i.e. prescription labels, on medicine containers contain information that is not immediately necessary for the patient and which is confusing. For patients who take many different medications on a daily or weekly basis, having to pick each medicine container up to decipher the dosage, timing, and type of medication can cause problems such as taking an incorrect dosage of the medication. Incorrectly understanding the contents and usage of a medication can lead to a medical condition going untreated, creating harmful side effects, and causing potential life-threatening medical emergencies for the patient.

### SUMMARY

According to a first aspect, the invention provides an indicator for identifying a condition to be treated by a medication. The medication is stored within a medicine container and the container is closed with a cap. The indicator includes a base and an upper component. The base is coupled to the cap of the medicine container. The upper component extends upwardly away from the base, is orthogonal to the cap, and includes a first side and a second side. The first side and second side of the upper component includes a usage indicia, which includes a visual representation of a condition to be treated by the medication. The usage indicia is supported by one of the first and second sides of the upper component such that the usage indicia is visible to the user. The upper component presents a surface area larger than an area of the cap to display the visual representation and the first and second sides are planar for easier viewing of the visual representation while the container is stored.

According to a second aspect, the invention also provides a cap for a medicine container including a body having an upper surface and an underside surface. The underside surface has a connector for mating with an opening of the medicine container for closing the opening. An indicator for identifying a condition to be treated by a medication, wherein the medication is stored within a medicine container. The medicine container is closed with a cap. The indicator includes a base and an upper component. The base is coupled to the cap of the medicine container. The upper component extends upwardly away from the base, is orthogonal to the cap, and includes a first side and a second side. The first side and second side of the upper component includes a usage indicia, which includes a visual representation of a condition to be treated by the medication. The usage indicia is supported by one of the first and second sides of the upper component such that the usage indicia is visible to the user. The upper component presents a surface area larger than an area of the cap to display the visual representation and the first and second sides are planar for easier viewing of the visual representation while the container is stored.

The subject invention provides information to be displayed to reduce potential confusion by showing the patient the needed information on a surface area that is larger than the cap of the medicine container or the surface area of the body of the medicine container. Examples of information to be displayed can be a picture of the condition to be treated, an easy-to-read dosage, whether the medication should be taken with food, and time of day of when to take the medication. This greatly reduces the potential confusion because the information being shown to the patient is condensed to a more manageable amount of information displayed on a larger surface area, which reduces the effort needed to ascertain the purpose of the medication. For non-English speaking patients, the visual representation can avoid serious mistakes and avoid adverse interactions. For the elderly, the larger sized information can similarly avoid life threatening mistakes.

### BRIEF DESCRIPTION OF THE DRAWINGS

Advantages of the present invention will be readily appreciated as the same becomes better understood by reference to the following detailed description when considered in connection with the accompanying drawings.

FIG. 1 is a perspective view of an indicator coupled to a medicine container according to a first embodiment.

FIG. 2 is a perspective view of the indicator decoupled from the medicine container according to the first embodiment with an attachment medium being in a hook-and-loop fastener arrangement.

FIG. 3 is a perspective view of the indicator coupled to the medicine container according to a second embodiment.

FIG. 4 is a perspective view of the indicator decoupled from the medicine container according to the second embodiment with the attachment medium being an adhesive.

FIG. 5 is a perspective view of the indicator coupled to the medicine container according to a third embodiment.

FIG. 6 is a perspective view of the indicator decoupled from the medicine container according to the third embodiment.

FIG. 7 is a perspective view of the indicator according to a fourth embodiment.

FIG. 8 is another perspective view of the indicator according to the fourth embodiment.

FIGS. 9-13 are various views of the indicator according to a fifth embodiment.

FIGS. 14-18 are various views of the indicator according to a sixth embodiment.

FIG. 19 is a perspective view of the indicator coupled to the medicine container according to a seventh embodiment.

FIG. 20 is a perspective view of the indicator decoupled from the medicine container according to the seventh embodiment.

FIGS. 21-23 are various views of the indicator according to the seventh embodiment.

FIGS. 24-28 are various views of the indicator according to a eighth embodiment.

### DETAILED DESCRIPTION

Referring to the Figures, wherein like numerals indicate like or corresponding parts throughout the several views, an indicator 30 for identifying a condition to be treated by a medication, wherein the medication is stored within a medicine container 32. It is to be appreciated that the term “medication” is intended to include, but is not limited to, drugs, supplements, vitamins, and the like, that are used in the diagnosis, cure, mitigation, treatment, or prevention of disease or conditions and/or are articles intended to affect the structure or any function of a body. The medication may or may not have been prescribed by a medical doctor.

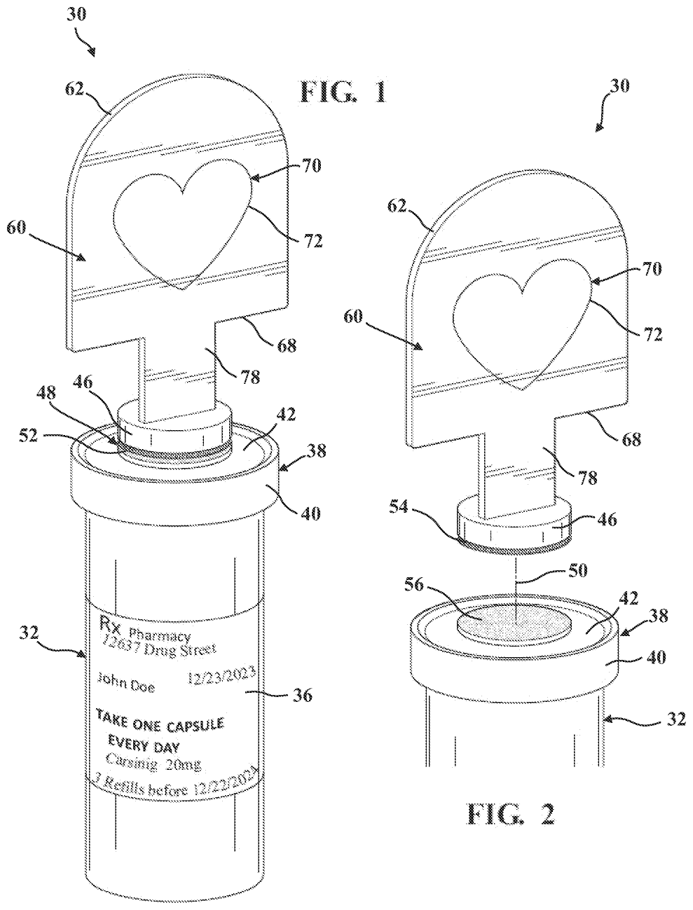

Medicine containers can come in different shapes and sizes. Medicine containers are often in bottle form and are frequently used for pills, tablets, capsules, or liquid medication. Medicine containers can be made from glass, which is particularly useful when storing liquid medicine. Medicine containers can be made of plastic, which is particularly useful when storing pills, tablets or capsules. Medicine containers come in a variety of colors and typically are orange or light brown, which helps keep ultraviolet light out while letting other light in so that the user can see the contents inside of the medicine container. Medicine containers can also be shaped in a traditional prescription bottle form, much like the medicine container 32 shown in FIG. 1.

The medicine container 32, shown in FIG. 1, is generally shaped as a cylinder with an opening 34 at one end and a flat base at the other. The medicine container 32 being substantially taller than a diameter of the opening 34 of the medicine container 32. The medicine container 32 shows a label 36, which should be appreciated to those skilled in the art as being a typical label on the medicine container 32. The flat base helps the medicine container 32 stand upright when stowed.

The opening 34 of the medicine container 32 is at the top, which is shown covered with a cap 38. The cap 38 includes a body 40 having an upper surface 42 and an underside surface. The underside surface has a connector for mating with the opening 34 of the medicine container 32. The connector helps close the medicine container 32. Caps on medicine containers can come in many forms and may include screw tops or snap-on caps without deviating from the subject invention. Modern medicine containers have caps that contain one or two raised sections above a ribbed base. Some caps come with a child-resistant top end and a non-child-resistant bottom end. This allows for a user who does not have small children to use the cap in a more convenient way by flipping the cap over bypassing the child-resistant end. The cap can be structured to require a downward force to remove the cap to open the medicine container. Caps may also require a twisting motion with the interior of the cap being threaded. Other kinds of caps do not require a twisting or a downward force and can be popped off the top portion of the medicine container.

The cap 38 shown in FIG. 1 has a diameter that is slightly larger than the diameter of the opening 34 of the medicine container 32. The cap 38 has a thickness to allow the user to grip the cap 38 to open the medicine container 32. The cap 38 may have a flat portion on top, which is slightly recessed as compared to an outer edge of the cap 38.

The indicator 30 includes a base 46, which is coupled to the cap 38 of the medicine container 32. The base 46 secures the indicator 30 to the cap 38 of the medicine container 32. The base 46 can vary in size depending on the medicine container 32 to which it is coupled. For example, the base 46 in FIG. 1 has a diameter, which is substantially smaller than the diameter of the cap 38 of the medicine container 32. FIG. 1 shows the base 46 of the indicator 30 having a circular shape and having ridges to aid the user in attaching and detaching the base 46 from the cap 38 of the medicine container 32.

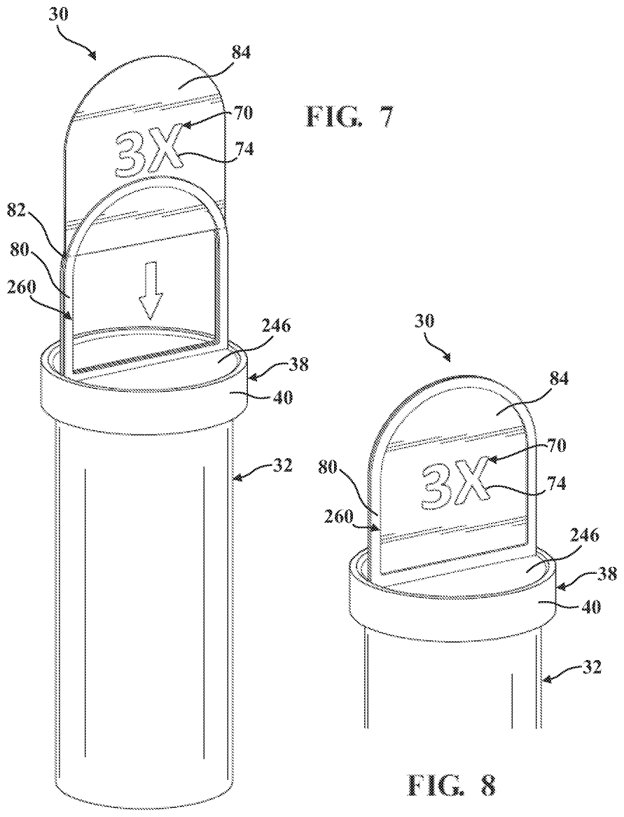

Referring to FIG. 5, the base 146 is shown having a circular shape but having a similar diameter as the cap 38 of the medicine container 32. The diameter is essentially the same size as the flat portion of the upper surface 42 of the cap 38 of the medicine container 32, i.e., nearly co-extensive with the cap 38. The diameter of the base 146 can be increased to help better stabilize the indicator 30 to the cap 38 on the medicine container 32. In another embodiment shown in FIG. 7, the base 246 has a similar diameter as the cap 38 of the medicine container 32.

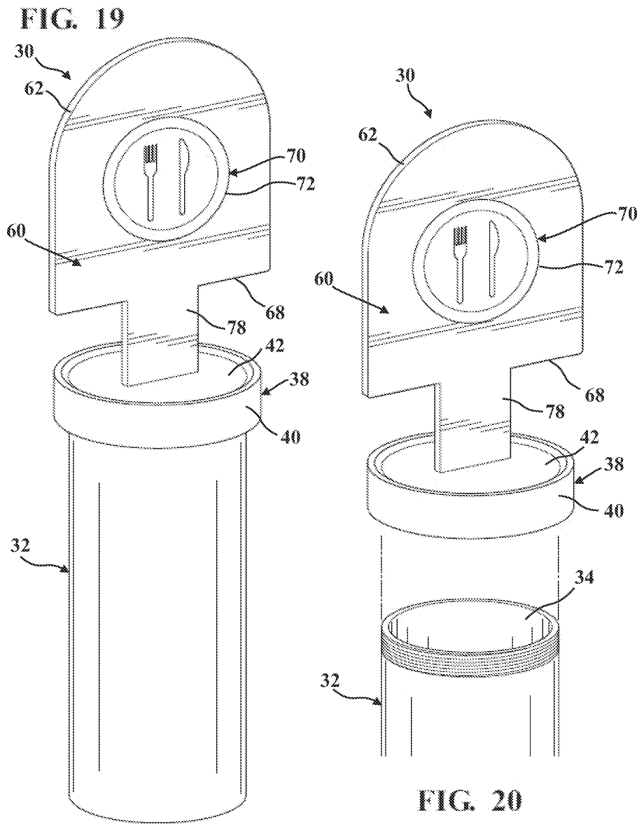

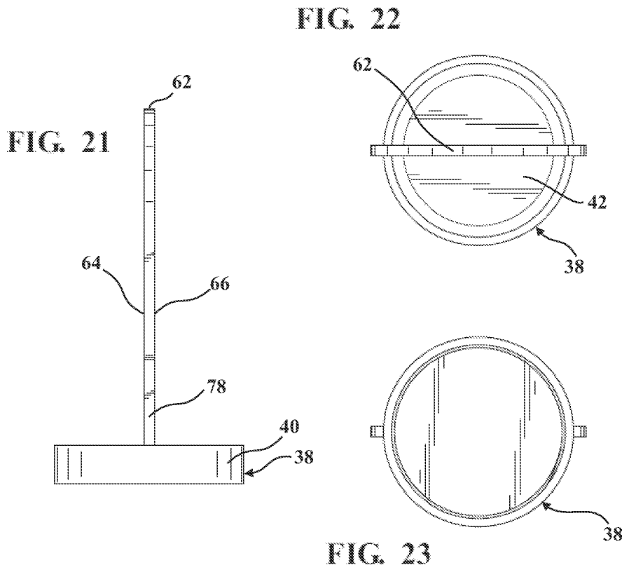

Alternatively, the base 46 can also be integrally formed with the cap 38, which can be seen in FIG. 19. This would further increase the stability and durability of the connection between the indicator 30 and the cap 38. The base 46 being integrally formed with the cap 38 may assist a patient who is repeatedly refilling the same medication.

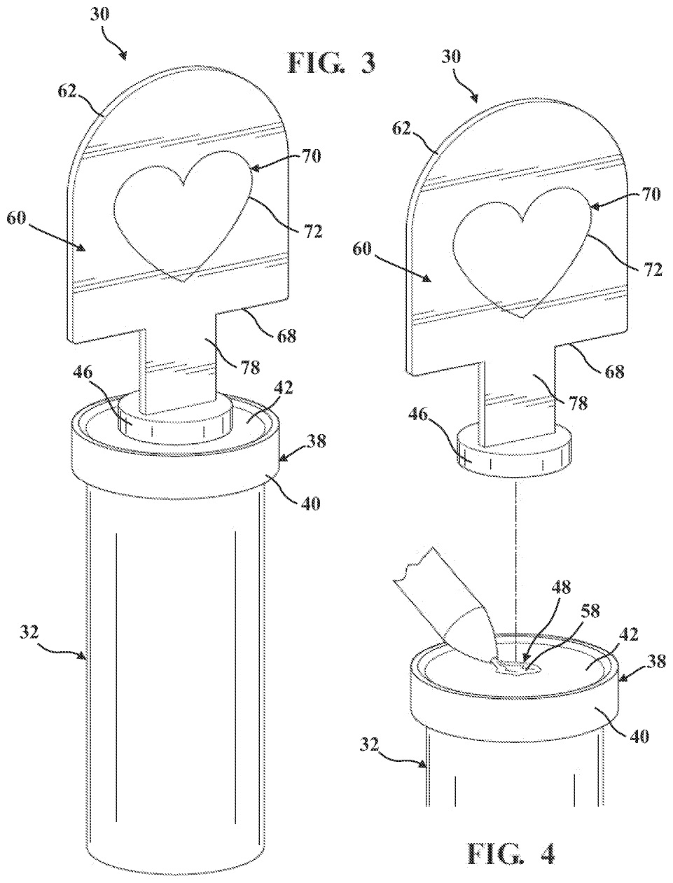

Referring back to FIG. 1, the base 46 of the indicator 30 is secured to the cap 38 of the medicine container 32 with an attachment medium 48. It should be appreciated to one of skill in the art that the attachment medium 48 can have many forms such as glue, adhesive, hook-and-loop fasteners, or any other type of medium. The attachment medium 48 can be a releasable connection 50 such that the indicator 30 can be removed from the cap 38 of the medicine container 32. In one embodiment, the attachment medium 48 has a hook portion 54 adhered to either the base 46 or the cap 38 and a loop portion 56 adhered to the other. Essentially, the attachment medium 48 can be one that temporarily secures the base 46 to the cap 38 of the medicine container 32, or permanently secures the base 46 to the cap 38 of the medicine container 32. For example, FIGS. 1 and 2 show the attachment medium 48 that is a hook-and-loop fastener 52 arrangement, which allows the indicator 30 to be detached from the cap 38 of the medicine container 32 and then later reattached by the user. The attachment medium 48, as seen in FIGS. 3 and 4, may have a more permanent arrangement. The attachment medium 48 can be an adhesive 58 disposed between the base 46 and the cap 38 to secure the indicator 30 to the medicine container 32. An advantage of a more permanent arrangement is that a user who refills a particular medication on a regular basis that uses the same type of medicine container can discard the original cap of the medicine container and replace the discarded cap with the indicator 30 attached cap. This can also be advantageous if the patient uses a third-party medicine container and wants to have the indicator 30 always attached to the third-party container. In this way, the third-party medicine container and the indicator 30 are always attached, and the patient knows that for that particular medicine container, a specific medication will fill the contents of that container.

With reference again to FIG. 1, the attachment medium 48 dictates where on the cap 38 the indicator 30 is attached, which is shown in the center of the upper surface 42 of the cap 38. The attachment medium 48 may cover the entire surface area of the bottom of the base 46 of the indicator 30 or a portion thereof. FIG. 2 shows this arrangement with the base 46 decoupled from the cap 38 of the medicine container 32 with the hook-and-loop fastener 52 arrangement visible. Referring now to FIGS. 3 and 4, the base 46 is adhered to the upper surface 42 of the cap 38 of the medicine container 32. The attachment medium 48 in this arrangement is not visible as the base 46 sits flush with the cap 38 of the medicine container 32. FIG. 4 shows the glue or adhesive 58 applied to the center of the upper surface 42 of the cap 38 of the medicine container 32 with a dotted line showing where the base 46 would be lowered onto the adhesive 58.

With reference to FIG. 1, the indicator 30 includes an upper component 60, which extends upwardly away from the base 46. The upper component 60 is orthogonal to the cap 38, and includes a first side 64 and a second side 66. The upper component 60 extends away from the base 46 to give the upper component 60 height so that the information displayed on the upper component 60 can be easily seen by the user. The upper component 60 is orthogonal from the base 46 so as to aid in the visibility. The first 64 and second 66 sides of the upper component 60 can be used to show duplicate information or differing information based on the medication contained within the medicine container 32. The upper component 60 having two sides also doubles the amount of surface area, which helps keep the information readable by using large, readable font.

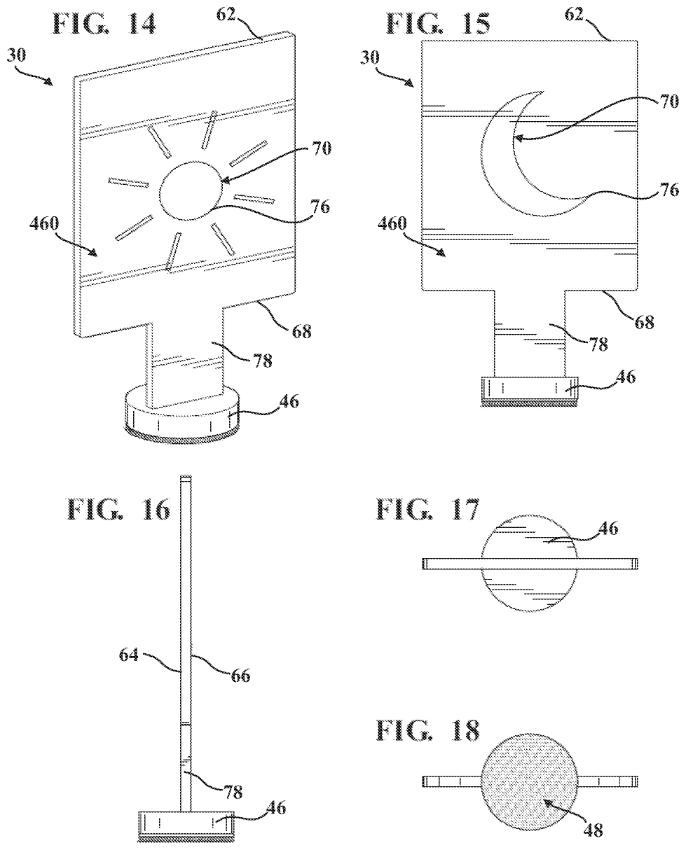

FIG. 1 further shows the upper component 60 extending upwardly away from the base 46 of the indicator 30. In the embodiment shown in FIG. 1, the upper component 60 is substantially wider than the base 46 and slightly wider than the flat portion of the upper surface 42 of the cap 38 of the medicine container 32. The upper component 60 has a flat bottom edge and is parallel with the upper surface 42 of the cap 38 of the medicine container 32. FIG. 1 shows the upper component 60 having a curved top edge 62. However, the upper component 460 can have a top edge 62 that is flat as seen in FIGS. 14 and 15. It should be appreciated that the top edge 62 of the upper component 60 can be a different shape than shown in FIGS. 1-2 and 14-15 without deviating from the subject invention.

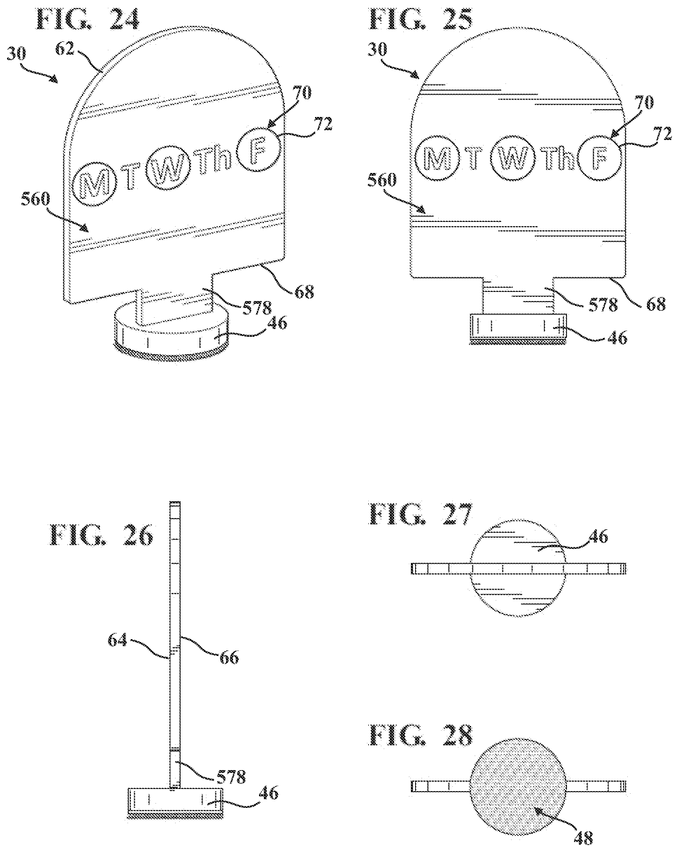

The first side 64 and second side 66 of the upper component 60 includes a usage indicia 70, which includes a visual representation 72 of the condition to be treated by the medication. The visual representation 72 can be a picture of the condition to be treated but can also show dosage, time of day to take the medication, whether to take the medication with food, or which days of the week the medication is to be taken. Illustrative examples of visual representations 72 include, but are not limited to, a heart as seen FIG. 1, a thyroid as seen in FIG. 5, a dosage indicator as seen in FIG. 7, when to take the medication as seen in FIG. 14, whether food is required as seen in FIG. 19, and days of the week to take the medication as seen in FIG. 24. It should be appreciated to those skilled in the art that there are many different types of visual representations that can be used to aid a patient in quickly ascertaining the type of medication and its requirements for effective use.

Referring to FIG. 7, the usage indicia 70 can include a dosage indicator 74 showing the appropriate dose of the medication to be consumed by the user. Dosage is a measure of quantity of a medication to be taken either at one time or over a period of time. A medication's dose has several factors, which are critical to the effectiveness of the medication's active ingredients. The first factor is the concentration, which is how much of the medication is being administered into the user's body at one time. The next factor is the duration of the exposure of the medication in the user's body. Both factors may be important to the medication's success in treating a particular condition. Dosage may be important in safeguarding the user from ingesting an incorrect amount of the medication. This can be in the form of taking too little of the medication, which could either cause the condition to go untreated, or otherwise negatively affecting the success rate of the medication. This can also be in the form of taking too much of the medication, which could either cause the condition to get worse, or create other side effects for the user that have the potential of being life-threatening.

Referring to FIGS. 14 and 15, the usage indicia 70 can have the visual representation 72 showing a time indicator 76 showing an approximate time that the medication is to be consumed by the user. For example, FIG. 14 shows a sun, which could signify to take the medication in the morning. Another example, FIG. 15 shows a moon, which could signify to take the medication at nighttime.

Referring to FIG. 19, the visual representation 72 shows a fork and a knife, which can indicate that the medication should be taken with food. Some medications are required to be taken with food to prevent side effects or help the medication work better by improving their absorption in the user's bloodstream. Food can also help protect the user's stomach from irritation caused by certain medications. For example, certain diabetes medications require to be taken with food to help prevent the user's blood sugar from dropping too low. Other examples of medications that typically need to be taken with food include corticosteroids, NSAIDs, and some antibiotics.

Referring back to FIG. 1, the visual representation 72 takes up most of the surface area of the upper component 60 and is generally placed in the center. However, the visual representation 72 shown in FIG. 1 is only one example. For example, the heart in FIG. 1 could be larger to encompass more of the surface area of the upper component 60. The heart also can be moved to a different location within the upper component 60 to allow for additional information to be displayed adjacent the heart. The visual representation 72 can also include non-English words for patients that do not speak English.

The usage indicia 70 is supported by one of the first 64 and second 66 sides of the upper component 60 or both such that the usage indicia 70 is visible to the user. The upper component 60 presents a surface area larger than an area of the cap 38 to display the visual representation 72. The upper component 60 having two sides is preferable in order to display different information on each side without having to compromise on surface area. For example, one side of the upper component 60 can display the condition to be treated by the medication, while the opposite side could display the dosage and time of day that the medication should be taken. Alternatively, both sides may have the same information displayed thereon. The first 64 and second 66 sides are planar for easier viewing of the visual representation 72 while the container is stored. The sides being planar allows the user to quickly identify the type of medication without having to pick up the medicine container 32 and reading the label 36. For example, it is not uncommon for a patient to be regularly taking multiple types of medication. The patient could have a row of medicine containers within a medicine cabinet with each medicine container having a corresponding indicator 30. The patient would be able to quickly identify which medicine they need without having to physically pick up any of the medicine containers. The increased surface area, as compared to the typical medicine container label or existing solutions allows for the information to be easily readable for the user. The user's convenience can alleviate potential problems such as incorrect dosage, taking the incorrect medication, or taking the medication at the wrong time.

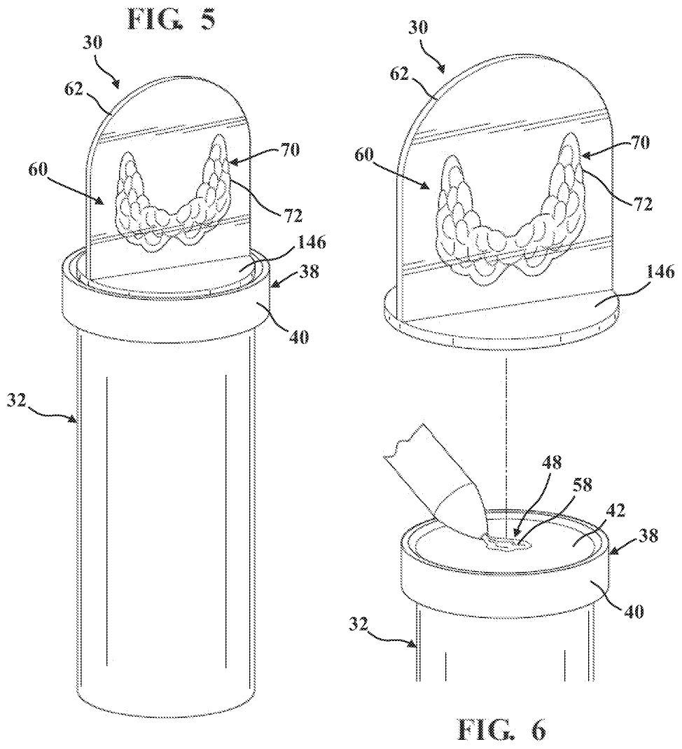

The indicator 30 may further include a stem 78 disposed between the base 46 and the upper component 60. The stem 78 extends away from the cap 38 to space the upper component 60 from the cap 38 allowing the usage indicia 70 to be displayed above the container for easier viewing. The stem 78 can vary in sizes and lengths. For example, FIGS. 1-4 show a stem 78 of a first length, FIGS. 5-8 show an embodiment with no stem, and FIGS. 24-25 show an embodiment with the upper component 560 with a shorter stem 578. FIG. 1 shows the stem 78 having a width that is smaller than the diameter of the base 46 and substantially smaller than the width of the upper component 60. The length of the stem 78 can be tailored for specific applications. For example, a longer stem 78 will raise the upper component 60 further away from the base 46 thereby making the user indicia 70 and visual representations 72 easier to see. However, a shorter stem 78 may be advantageous as it decreases the height of the overall indicator 30, which may make the indicator 30 and medicine container 32 easier for storage. Also, the user may want there to be no stem as shown in FIGS. 5-8, which would decrease the overall height of the indicator 30 and may make the connection between the upper component 60 and the base 46 sturdier.

An additional embodiment is shown in FIGS. 7 and 8 having the upper component 260 that includes a frame 80 substantially surrounding and defining an opening 82 for receiving the usage indicia 70. In this embodiment, the usage indicia 70 also includes an insert 84 configured to be received by the opening 82 of the frame 80 such that the usage indicia 70 can be changed based on the medication in the container. The usage indicia 70 is removeable from the upper component 260 to allow for different identification of conditions to be treated. For example, FIGS. 7 and 8 show the visual representation 72 depicting dosage information. The frame 80 is permanently adhered to the upper surface 42 of the cap 38, whereas the insert 84 is interchangeable. This arrangement allows for the user to replace the insert 84 while continuing to use the existing medicine container 32.

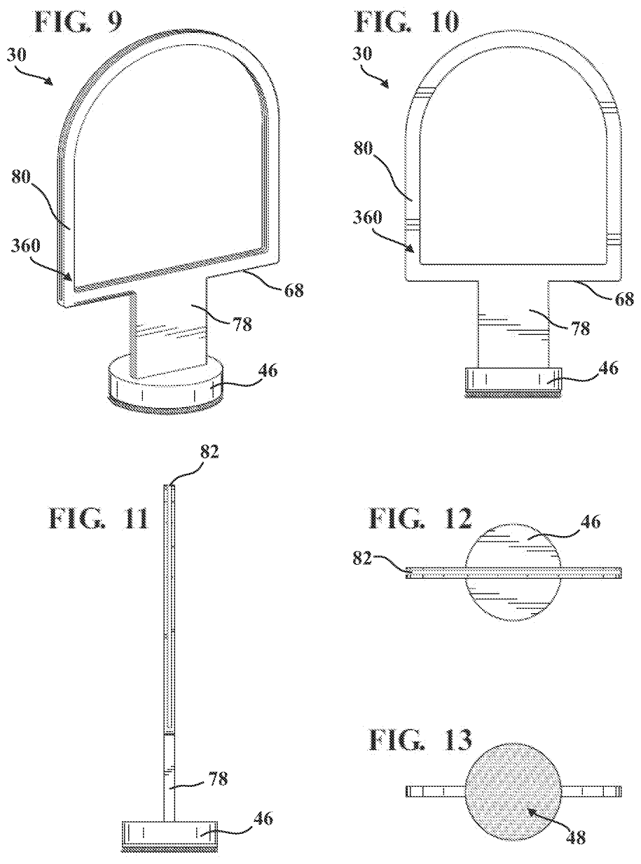

FIG. 7 shows the upper component 260 adhered directly to the upper surface 42 of the cap 38 of the medicine container 32. The bottom of the frame 80 has a similar length as the diameter of the cap 38 of the medicine container 32. The frame 80 extends upwards and is has a curved top edge 62. It should be appreciated that the frame 80 could also have a flat top edge 62 instead of a curved top edge 62. FIG. 9 shows a similar arrangement with the frame 80 with the insert 84, however, the upper component 360 includes a stem 78.

Several implementations have been discussed in the foregoing description. However, the implementations discussed herein are not intended to be exhaustive or limit the invention to any particular form. The terminology which has been used is intended to be in the nature of words of description rather than of limitation. Many modifications and variations are possible in light of the above teachings and the invention may be practiced otherwise than as specifically described.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. An indicator for identifying a condition to be treated by a medication stored within a medicine container that is closed with a cap, said indicator comprising:
a base coupled to the cap of the medicine container;
an upper component extending upwardly for said base and orthogonal to the cap and having a first side and a second side;
a usage indicia comprising a visual representation of a condition to be treated by the medication and supported by one of said first and said second sides of said upper component such that said usage indicia is visible to a user; and
wherein said upper component presents a surface area larger than an area of the cap to display said visual representation and said first and said second sides are planar for easier viewing of said visual representation while the container is stored.

2. An indicator as set forth in claim 1, wherein said usage indicia further comprises a dosage indicator indicating an appropriate dose of the medication to be consumed by the user.

3. An indicator as set forth in claim 2, wherein said usage indicia further comprises a time indicator indicating an approximate time that the medication is to be consumed by the user.

4. An indicator as set forth in claim 1, further comprising an attachment medium securing said base to the cap.

5. An indicator as set forth in claim 4, wherein said attachment medium is further defined as a releasable connection such that said indicator can be removed from the cap.

6. An indicator as set forth in claim 5, wherein said attachment medium is further defined as a hook-and-loop-fastener with a hook portion adhered to one of said base or the cap and a loop portion adhered to the other.

7. An indicator as set forth in claim 4, wherein said attachment medium is further defined as an adhesive disposed between said base and the cap to secure said indicator thereto.

8. An indicator as set forth in claim 1, wherein said base is integrally formed with the cap.

9. An indicator as set forth in claim 1, further comprising a stem disposed between said base and said upper component and extending away from the cap to space said upper component from the cap for allowing the usage indicia to be displayed above the container for easier viewing.

10. An indicator as set forth in claim 1, wherein said upper component is further defined as comprising a frame substantially surrounding and defining an opening for receiving said usage indicia.

11. An indicator as set forth in claim 10, wherein said usage indicia is further defined as an insert configured to be received by said opening of said frame such that said usage indicia can be changed based on the medication in the container.

12. An indicator as set forth in claim 1, wherein said usage indicia is removeable from said upper component to allow for different identification of conditions to be treated.

13. A cap for a medicine container comprising:
a body having an upper surface and an underside surface, said underside surface having a connector for mating with an opening of a medicine container for closing the opening; and an indicator for identifying a condition to be treated, said indicator comprising;
a base coupled to said cap of the medicine container,
an upper component extending upwardly for said base and orthogonal to said cap and having a first side and a second side,
a usage indicia comprising a visual representation of a condition to be treated by the medication and supported by one of said first and said second sides of said upper component such that said usage indicia is visible to a user; and
wherein said upper component presents a surface area larger than an area of said cap to display said visual representation and said first and said second sides are planar for easier viewing of said visual representation while the container is stored.

14. A cap as set forth in claim 13, wherein said indicator further comprises a stem disposed between said base and said upper component and extending away from said cap to space said upper component from said cap for allowing the usage indicia to be displayed above the container for easier viewing.

15. A cap as set forth in claim 13, wherein said base is integrally formed with said cap.

16. A cap as set forth in claim 13, further comprising an attachment medium securing said base to said cap.

17. A cap as set forth in claim 16, wherein said attachment medium is further defined as a releasable connection such that said indicator can be removed from said cap.

18. A cap as set forth in claim 17, wherein said attachment medium is further defined as a hook-and-loop-fastener with a hook portion adhered to one of said base or said cap and a loop portion adhered to the other.

19. A cap as set forth in claim 17, wherein said attachment medium is further defined as an adhesive disposed between said base and said cap to secure said indicator thereto.
